(19) United States
(12) Patent Application Publication
(10) Pub. No.: US 2026/0326269 A1
(43) Pub. Date: Oct. 22, 2026

(54) Electric Fence Insulator Tool and Associated Assemblies and Methods

(71) Applicants: David Alan Holloway, Chattanooga, OK (US); Jake Alan Holloway, Skiatook, OK (US)

(72) Inventors: David Alan Holloway, Chattanooga, OK (US); Jake Alan Holloway, Skiatook, OK (US)

(21) Appl. No.: 19/648,032

(22) Filed: Apr. 15, 2026

Related U.S. Application Data
(60) Provisional application No. 63/789,474, filed on Apr. 16, 2025.

(51) Int. Cl. B25B 13/50; A01K 3/00; H01B 17/14

(52) U.S. Cl. CPC B25B 13/50; A01K 3/005; H01B 17/14

(57) ABSTRACT

An example tool for engaging an insulator of an electric fence includes: a tool body having an insulator gripping portion; a receptacle formed within the insulator gripping portion and configured to receive at least a portion of the insulator therein; and one or more ear pockets formed within the insulator gripping portion, wherein the one or more ear pockets are configured to receive respective ears of the insulator to rotatably engage with the insulator.

### CROSS-REFERENCE TO RELATED APPLICATIONS

This application claims priority to U.S. Provisional Application No. 63/789,474, titled Electric Fence Insulator Tool and Associated Assemblies and Methods, filed Apr. 16, 2025, which is hereby incorporated by reference in its entirety.

### BACKGROUND

An electric fence is a type of barrier that uses a controlled electric shock to deter animals or people from crossing it, typically used for livestock control on farms, perimeter security, or wildlife management. An electric fence uses an energizer (also called a fence charger) that emits brief, high-voltage pulses of electricity, and these pulses travel along conductive wires (or netting) that are strung along posts or stakes, which could be wooden or metallic (e.g., reinforcing bar or smooth bar). The other end of the energizer is connected to ground rods driven into the earth, providing a path for the electrical current to return to the energizer.

When an animal touches the live wire, the electrical current completes the circuit through its body and into the ground, causing a brief, but noticeable shock. The shock is designed to condition animals to avoid the fence in the future.

Electric fences typically have insulators that prevent short-circuiting by keeping the conductive wires or ribbon from touching the posts or stakes. Particularly, an electric fence insulator is a component made from an electrically-insulating material (e.g., plastic) and is configured to securely fasten electrified wire to fence posts, preventing electrical energy from escaping into the post and causing short circuits, ensuring the fence's proper function and safety.

Typically, these insulators are inserted or otherwise attached to the stakes, which are driven partially into the ground. The stakes may stand 3-6 feet tall above ground, for example. The insulators may then be loosened and moved to adjust their location as desired, and are then retightened to secure them to the stakes before hanging or attaching the electric wires to the insulators.

This process may involve adjusting and tightening hundreds of insulators on a farm, for example. This process is thus tedious, time consuming, physically demanding, and may cause fatigue and hand injuries, particularly in an aging farm population, for example.

It may thus be desirable to have a tool that enhances or simplifies loosening and tightening insulators, while reducing the effort required. It is with respect to these and other considerations that the disclosure made herein is presented.

### SUMMARY

The present disclosure describes implementations that relate to electric fence insulator tools and associated assemblies and methods.

Within examples, an insulator may have a component with ears or teeth protruding or projecting therefrom. In an example implementation, the tool is configured to have an inner surface forming one or more ear pockets that receive such ears or teeth therein. This facilitates or simplifies engaging the insulator. The tool can then be rotated either by hand or via a wrench to increase mechanical leverage. The tool thus simplifies engaging the insulators, and reduces the effort required to loosen or tighten them.

In an example implementation, the present disclosure also describes a method of using the tool. In another example implementation, the present disclosure also describes an assembly of the tool with an insulator.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a schematic representation of a portion of an electric fence, according to an example implementation.

FIG. 2 illustrates a stake or post with various types of insulators mounted thereto, according to an example implementation.

FIG. 3A illustrates a side view of an insulator in an unassembled state, according to an example implementation.

FIG. 3B illustrates a bottom view of the insulator of FIG. 3A in the unassembled state, according to an example implementation.

FIG. 4A illustrates a perspective bottom view of a tool, according to an example implementation.

FIG. 4B illustrates a top perspective view of the tool of FIG. 4A, according to an example implementation.

FIG. 4C illustrates a side view of the tool of FIG. 4A, according to an example implementation.

FIG. 4D illustrates a bottom view of the tool of FIG. 4A, according to an example implementation.

FIG. 5A illustrates a perspective bottom view of a tool, according to an example implementation.

FIG. 5B illustrates a side view of the tool of FIG. 5A, according to an example implementation.

FIG. 5C illustrates a top view of the tool of FIG. 5A, according to an example implementation.

FIG. 5D illustrates a bottom view of the tool of FIG. 5A, according to an example implementation.

FIG. 6 illustrates a perspective view of an assembly of the tool of FIGS. 5A-5D engaging an insulator, according to an example implementation.

FIG. 7 illustrates a perspective view of an assembly of the tool of FIGS. 5A-5D engaging an insulator, according to an example implementation.

FIG. 8 is a flowchart of a method for securing an insulator to a post of an electric fence, according to an example implementation.

### DETAILED DESCRIPTION

Within examples, disclosed herein are electric fence insulator tools and associated methods. An insulator may have a component with teeth or ears protruding or projecting therefrom. The tool is configured to have a receptacle and one or more ear pockets that receive the ears of the insulator therein. The tool can then be rotated either by hand or via a wrench to have mechanical leverage. The tool thus simplifies engaging the insulators, and reduces the effort required to loosen or tighten them.

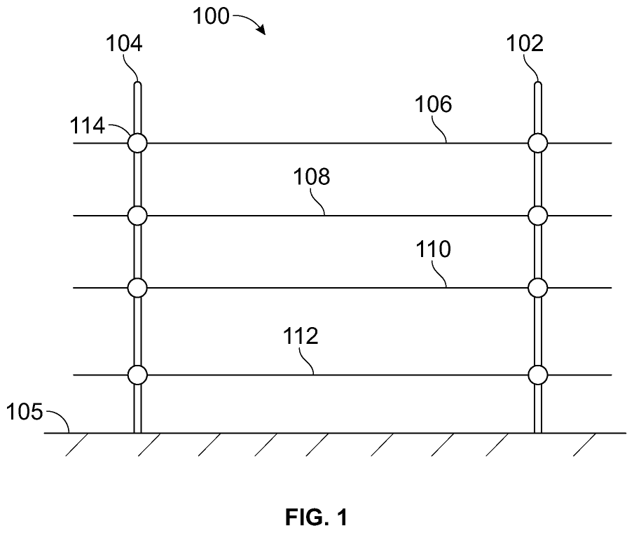

FIG. 1 illustrates a schematic representation of a portion of an electric fence 100, according to an example implementation. The electric fence 100 includes stakes or posts such as post 102 and post 104 that are driven partially through ground 105. The electric fence 100 also includes a plurality of wires, such as wire 106, wire 108, wire 110, and wire 112, attached to the posts 102, 104 via insulators such as insulator 114.

Particularly, the insulator 114 is coupled to the post 104, and the wire 106 can then be passed through a channel made in the insulator 114, for example. FIG. 1 shows seven other insulators that are coupled to the posts 102, 104, and the wires 106-112 are hung or passed through them.

FIG. 1 shows a partial view of the electric fence 100. An electric fence may include many posts and hundreds of insulators.

The electric insulators, such as the insulator 114, are used to securely fasten the wires 106-112, which are electrified, to the posts 102, 104, preventing electrical energy from escaping into the posts 102, 104 and causing short circuits, thus ensuring proper operation and safety of the electric fence 100. Insulators are typically made from materials that are good electrical insulators, such as plastic (polyethylene, polycarbonate, or nylon) or porcelain (clay, quartz, and feldspar). Different types of insulators exist to accommodate various fence post types (e.g., wood, T-posts, metal) and wire types (e.g., wire, rope, ribbon, tape). Proper insulator installation is desirable for a strong, reliable, and safe electric fence, ensuring that the fence maintains its electric charge to effectively deter livestock or other animals.

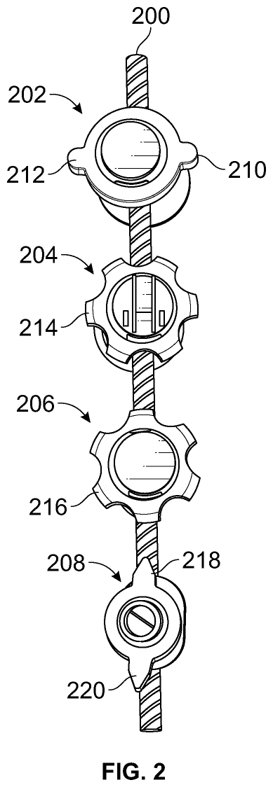

FIG. 2 illustrates a post 200 with various types of insulators mounted thereto, according to an example implementation. Particularly, FIG. 2 depicts four insulators: insulator 202, insulator 204, insulator 206, and insulator 208 that represent example implementations of insulators.

Each of the insulators 202-208 may have teeth or ears that protrude or project radially outward therefrom. For example, the insulator 202 has two teeth or ears: ear 210 and ear 212. The insulator 204 is configured as a gear wheel having a plurality of teeth or ears, such as ear 214. The insulator 206 is similar to the insulator 204 and is configured as a gear wheel having a plurality of teeth or ears, such as ear 216. The insulator 208 similarly has two ears, ear 218 and ear 220, each ear having a pointy tip. These insulators are examples for illustration, and other types and configurations of insulators may be used. The illustrated insulators have ears to facilitate engaging and rotating them to secure the insulators to the posts of the electric fence.

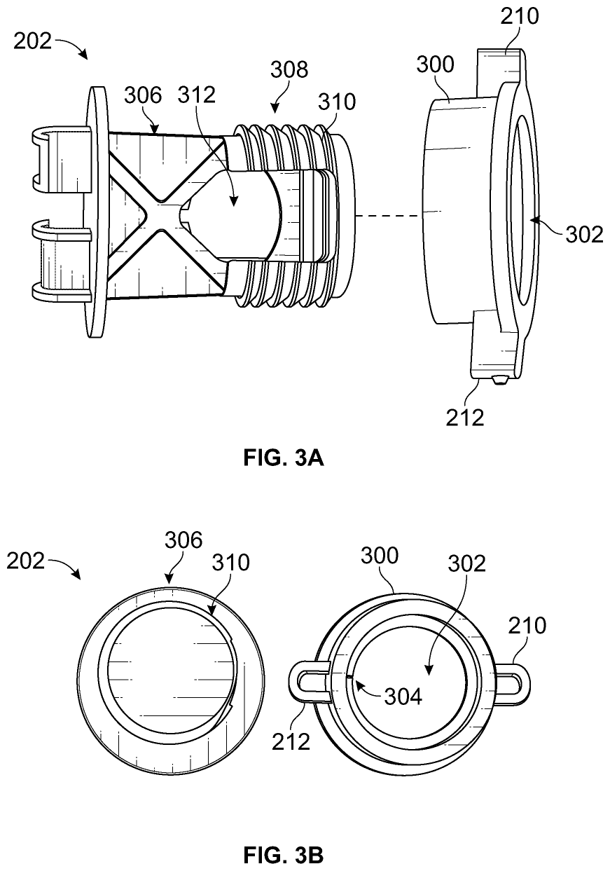

FIG. 3A illustrates a side view of the insulator 202 in an unassembled state, and FIG. 3B illustrates a bottom view of the insulator 202 in the unassembled state, according to an example implementation. As shown, the insulator 202 has a first component 300 having the ears 210, 212. The first component 300 also has a central hole 302, and internal threads 304 bounding the central hole 302.

The insulator 202 also has a second component 306. Both of the components 300, 306 may be made of plastic material, for example. The second component 306 may have a split portion 308 that is configured to be bifurcated or have a split to render the second component 306 flexible and able to tighten over the post of the electric fence to which the insulator 202 is to be mounted.

The second component 306 has external threads 310 formed in the split portion 308. The second component 306 also has a hole or aperture 312 through which the post of the electric fence is inserted. Particularly, the second component 306 can be inserted from a top end of the post such that the post is inserted through the aperture 312 of the second component 306.

Once the second component 306 is at a desired position, the first component 300 can be rotated. As the internal threads 304 of the first component 300 engage the external threads 310 of the second component 306, the split portion 308 is tightened, reducing the size of the aperture 312 and securing the insulator 202 to the post inserted through the aperture 312.

The first component 300 can be rotated by hand or via pliers, for example. Particularly, a user may manually engage the ears 210, 212 to rotate the first component 300 and tighten the second component 306 as mentioned above. However, this process has traditionally been difficult, time-consuming, and physically demanding due to the need for manual gripping or the use of pliers, which frequently slip and cause fatigue, frustration, and potential hand injuries.

This is exacerbated by the need to repeat this process for hundreds of insulators in a typical electric fence. Further, adjustments are sometimes required where the insulator is loosened (e.g., the first component 300 is unthreaded to loosen the grip of the second component 306 over the post) then retightened once the second component 306 is slid vertically to a desired position. As such, an ergonomic tool that simplifies the tightening and loosening of electric fence insulators may be desirable.

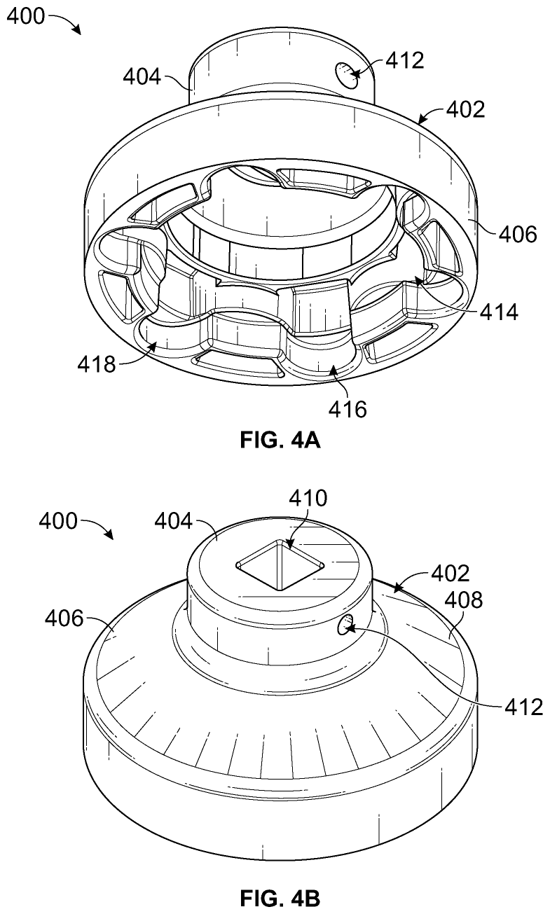

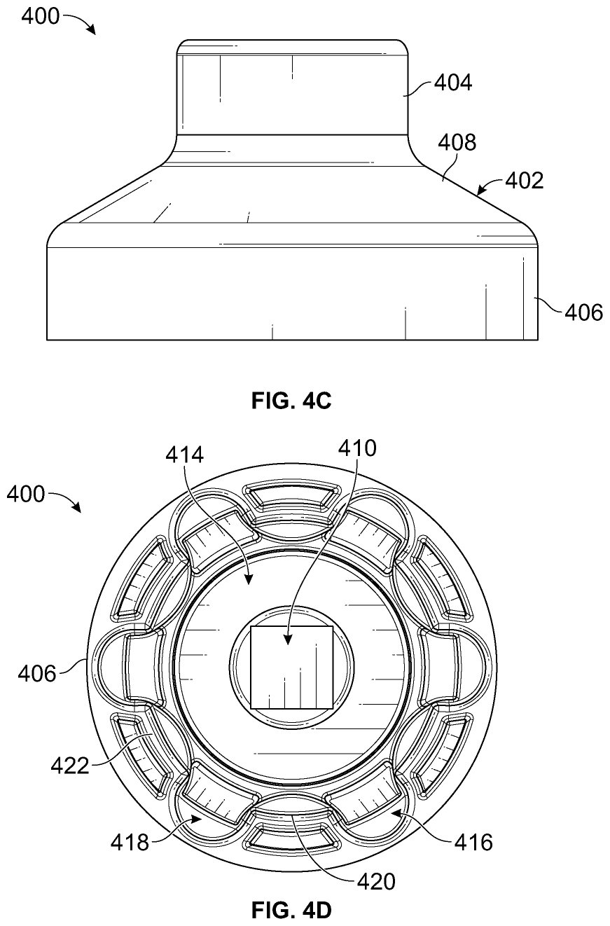

FIG. 4A illustrates a perspective bottom view of a tool 400, FIG. 4B illustrates a top perspective view of the tool 400, FIG. 4C illustrates a side view of the tool 400, and FIG. 4D illustrates a bottom view of the tool 400, according to an example implementation. FIGS. 4A-4D are described together.

As shown, the tool 400 has a tool body 402 that is configured to be made as a lightweight, one-piece component of engineered polymer (plastic), for example. The tool body 402 has a small diameter portion or head portion 404 that operates as a wrench interface portion. The tool body 402 further includes a larger diameter portion that operates an insulator gripping portion 406. A tapered portion 408 connects the head portion 404 to the insulator gripping portion 406. The tool body 402 is generally hollow as depicted in FIGS. 4A, 4D, for example.

In an example, the head portion 404 may have a socket drive hole 410 and a socket drive detent hole 412. The socket drive hole 410 is configured to allow engaging a ratcheting, wrench, cordless ratchet, or drill, for example, with the tool 400. This facilitates rotating the tool 400 with ease (e.g., with mechanical leverage) via a break-over wrench or ratchet, for example. In examples, the socket drive hole 410 can be formed from during the plastic molding process or from a machined or cast metal part that is insert molded during the plastic molding process of the tool body 402.

A male portion of a ratchet typically has a spring-loaded ball detent on the side of the square male portion that is used to retain the socket (mating part). In the example implementation of the tool body 402, the detent hole 412 may operate in a similar manner.

Further, the insulator gripping portion 406 has a receptacle 414 configured to receive at least a portion of the insulator of the electric fence and engage the ears of the insulator (e.g., any of the ears of any of the insulators shown in FIG. 2). As depicted in FIGS. 4A, 4D, for example, the interior surface of the insulator gripping portion 406 is contoured to form ear pockets such as ear pocket 416 and ear pocket 418 among others.

In other words, the insulator gripping portion 406 is configured as internal gear having internal protrusions or teeth, such as tooth 420 and tooth 422, with ear pockets being interleaved, or formed circumferentially or circularly, there between to receive the ears of the insulators therein. For example, the ear pocket 418 is formed between, or is circularly interposed between, the teeth 420, 422, and so on.

With this configuration, the tool 400 can be mounted to various types of insulators (e.g., any of the insulators 202-208) such that the ears of the insulator are received in the ear pockets of the tool 400, thereby rotatably engaging with the insulator. The tool 400 can then be rotated (e.g., via a wrench) to tighten the insulator over the post to which it is mounted.

In some examples, a handle may be added to, or integrated with, the tool 400 to further facilitate rotation of the tool 400, while enhancing mechanical leveraging. For example, a tee-shaped (T-shaped) handle may be added to the insulator gripping portion 406.

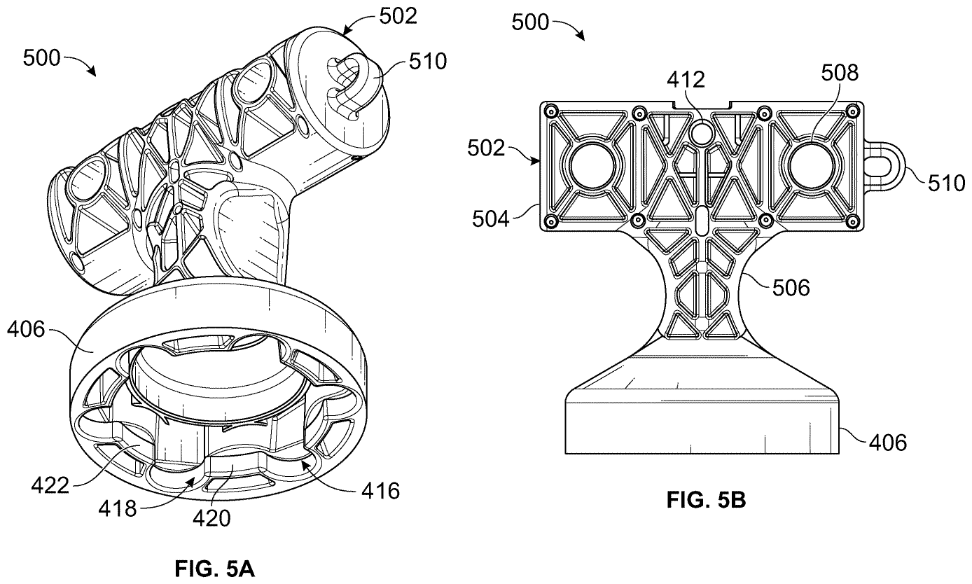

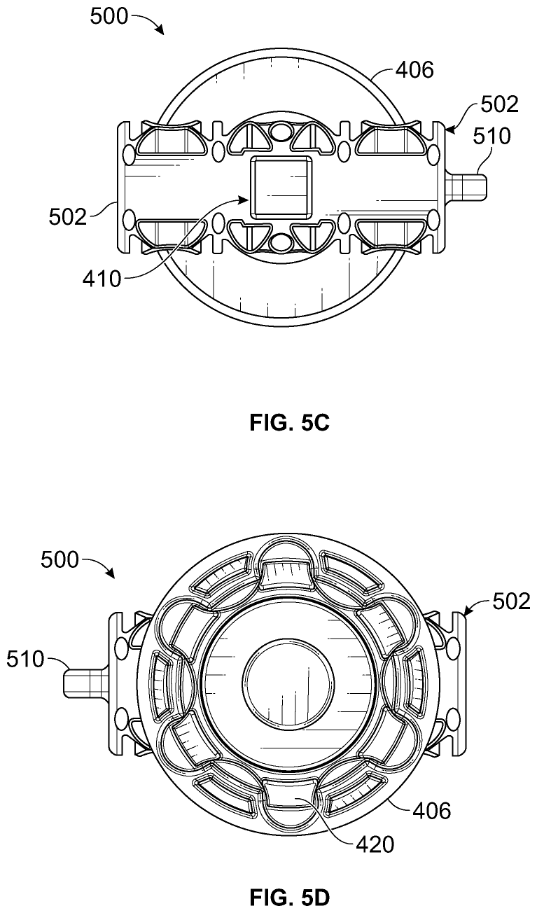

FIG. 5A illustrates a perspective bottom view of a tool 500, FIG. 5B illustrates a side view of the tool 500, FIG. 5C illustrates a top view of the tool 500, and FIG. 5D illustrates a bottom view of the tool 500, according to an example implementation. FIGS. 5A-5D are described together.

The tool 500 has the insulator gripping portion 406 (of the tool 400), which is configured to engage various types of insulators as described above. The tool 500 further includes a handle 502 that is generally tee-shaped such that the handle 502 has a horizontal or lateral portion 504 and a vertical or transversal portion 506. In an example implementation, as shown in FIG. 5B, the transversal portion 506 may have an hour-glass shape for ergonomic purposes to facilitate manually holding the handle 502.

In one example, the tool 500 can be a monolithic plastic part that is injection molded, and as such it may have several cavities or hollow portions as depicted in FIGS. 5A-5D to reduce weight by reducing the amount of material used. This configuration may also prevent shrinking and deforming the tool 500 during the injection molding process.

In another example, the tool 500 can be made using additive manufacturing processes, such as three-dimensional printing. In this example, the tool 500 might not have the cavities, but may be hollow to reduce weight.

In an example, the tool 500 may have one or more holes (e.g., through-holes) in the lateral portion 504, such as hole 508. These holes can facilitate mounting the tool 500 on a wall or other surfaces for storage, for example. The lateral portion 504 may also have the socket drive hole 410 and the socket drive detent hole 412. In some examples, a metal insert (e.g., a metal square drive insert) having a socket may be inserted in the socket drive hole 410 in the tool 500 (which could be made of plastic).

In one example, the tool 500 may have a loop 510 (e.g., a Lanyard loop) attached to the lateral portion 504 or other portions of the tool 500. A retractable cable may be attached to the tool 500 via the loop 510, and the retractable cable may be mounted to a belt of a user, for example. During use of the tool 500, the user can grab the tool 500, extend the cable and use the tool 500, then release it, and the tool 500 would be retracted to a position close to the belt of the user. This way, the user might not be concerned about misplacing the tool 500 and may readily access it when needed.

The tools 400, 500 are configured to accommodate various insulators. Any of the insulators 202-208 of FIG. 2 can be accommodated by the tools 400, 500, for example.

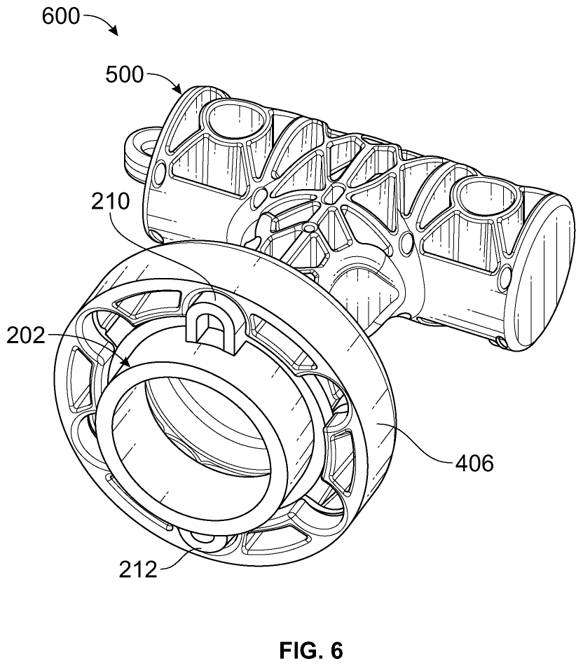

FIG. 6 illustrates a perspective view of an assembly 600 of the tool 500 engaging the insulator 202, according to an example implementation. As shown, the insulator gripping portion 406 of the tool 500 is mounted to and is engaged with the insulator 202 such that the insulator 202 is partially received or disposed within the receptacle 414 (see FIGS. 4A, 4D) and the ears 210, 212 of the insulator 202 are received within respective ear pockets of the insulator gripping portion 406. This way, the tool 500 is engaged with the insulator 202 similar to how a ring gear engages a pinion disposed therein, for example. With this configuration, rotating the tool 500 causes the insulator 202 to rotate therewith, tightening the insulator 202 over a post (not shown) of the electric fence.

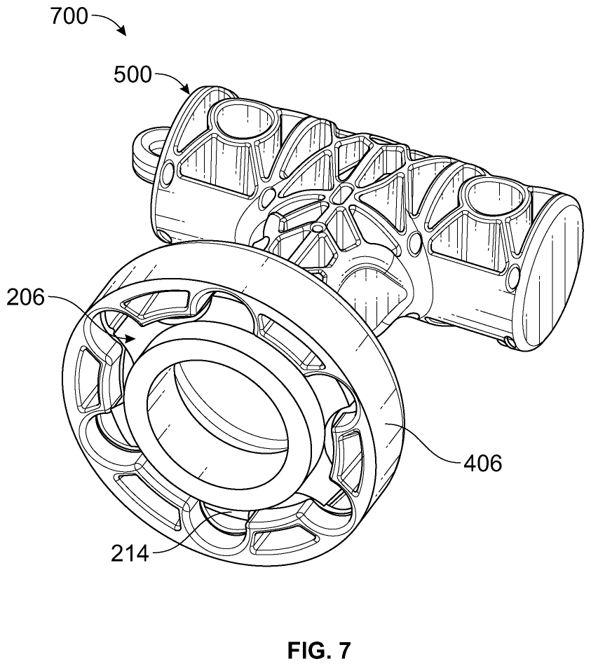

FIG. 7 illustrates a perspective view of an assembly 700 of the tool 500 engaging the insulator 206, according to an example implementation. As shown, the insulator gripping portion 406 of the tool 500 is mounted to and is engaged with the insulator 206 such that is partially received or disposed within the receptacle 414 (see FIGS. 4A, 4D) the ears (e.g., the ear 214) of the insulator 206 are received within respective ear pockets of the insulator gripping portion 406. This way, the tool 500 is engaged with the insulator 206. With this configuration, rotating the tool 500 causes the insulator 206 to rotate therewith, tightening the insulator 206 over a post of the electric fence.

Although FIGS. 6-7 show the tool 500, the tool 400 could be used instead. Also, although no wrench is shown, it may be desirable in some cases to use a wrench to increase mechanical leverage. Regardless of whether a wrench is used or not, the tools 400, 500 simplify the tightening and loosening of electric fence insulators, while being time-efficient, not physically demanding, thereby reducing frustration and potential hand injuries.

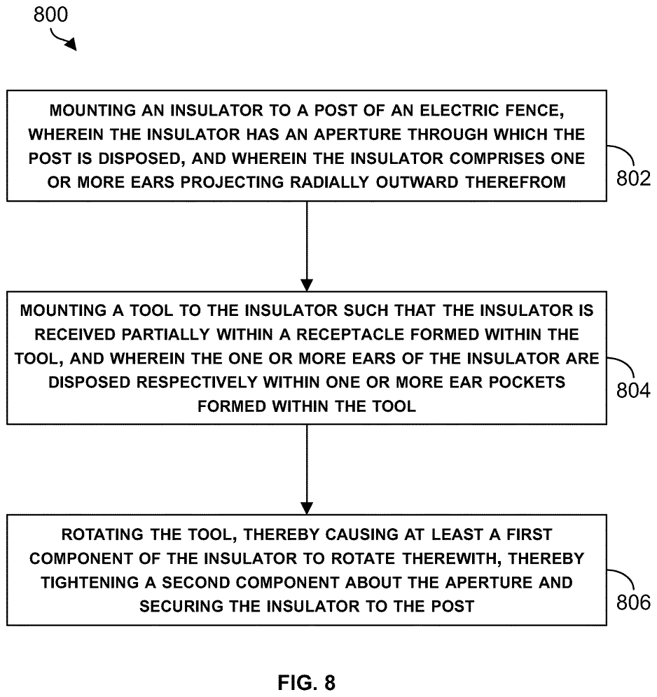

FIG. 8 is a flowchart of a method 800 for securing an insulator to a post of an electric fence, according to an example implementation. For example, the method 800 can be used to secure any of the insulators (e.g., the insulator 202-208) described above to one of the posts 102, 104 of the electric fence 100.

The method 800 may include one or more operations, functions, or actions as illustrated by one or more of blocks 802-806. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 802, the method 800 includes mounting an insulator (e.g., the insulator 202) to a post of an electric fence, wherein the insulator has an aperture (e.g., the aperture 312) through which the post is disposed, and wherein the insulator comprises one or more ears (e.g., the ears 210, 212) projecting radially outward therefrom.

At block 804, the method 800 includes mounting the tool 400, 500 to the insulator such that the insulator is received partially within the receptacle 414 formed within the tool 400, 500, and wherein the one or more ears of the insulator are disposed respectively within one or more ear pockets (e.g., the ear pockets 416, 418) formed within the tool 400, 500.

At block 806, the method 800 includes rotating the tool 400, 500, thereby causing at least a first component (e.g., the first component 300) of the insulator to rotate therewith, thereby tightening a second component (e.g., the second component 306) about the aperture and securing the insulator to the post.

The method 800 can further include any of the other steps or operations described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a tool for engaging an insulator of an electric fence, the tool comprising: a tool body having an insulator gripping portion; a receptacle formed within the insulator gripping portion and configured to receive at least a portion of the insulator therein; and one or more ear pockets formed within the insulator gripping portion, wherein the one or more ear pockets are configured to receive respective ears of the insulator to rotatably engage with the insulator.

EEE 2 is the tool of EEE 1, wherein the tool body comprises: a head portion, wherein the head portion comprises a socket drive hole.

EEE 3 is the tool of EEE 2, wherein the head portion has a smaller diameter compared to the insulator gripping portion.

EEE 4 is the tool of EEE 3, wherein the tool body further comprises: a tapered portion that connects the head portion to the insulator gripping portion.

EEE 5 is the tool of any of EEEs 1-4 wherein an interior surface of the insulator gripping portion is contoured to form the one or more ear pockets.

EEE 6 is the tool of any of EEEs 1-5 wherein the insulator gripping portion has a plurality of internal protrusions, and wherein the one or more ear pockets are interleaved between the plurality of internal protrusions.

EEE 7 is the tool of any of EEEs 1-6 further comprising: a handle coupled to the insulator gripping portion.

EEE 8 is the tool of EEE 7, wherein the handle is tee-shaped such that the handle has a lateral portion and a transversal portion.

EEE 9 is the tool of EEE 8, wherein the transversal portion has an hour-glass shape.

EEE 10 is the tool of any of EEEs 8-9, wherein the lateral portion has one or more holes to facilitate mounting the tool on a surface.

EEE 11 is the tool of any of EEEs 8-10 wherein the lateral portion has a loop attached thereto.

EEE 12 is an assembly comprising: an insulator of an electric fence, wherein the insulator comprises one or more ears projecting radially outward therefrom; and any of the tools of EEEs 1-11 for rotatably engaging the insulator. For example, the tool comprises: a tool body having an insulator gripping portion, a receptacle formed within the insulator gripping portion, wherein the insulator is received partially within the insulator gripping portion, and one or more ear pockets formed within the insulator gripping portion, wherein the one or more ears of the insulator are disposed within the one or more ear pockets.

EEE 13 is the assembly of EEE 12, wherein the tool body comprises: a head portion, wherein the head portion comprises a socket drive hole.

EEE 14 is the assembly of EEE 13, wherein the tool body further comprises: a tapered portion that connects the head portion to the insulator gripping portion.

EEE 15 is the assembly of any of EEEs 12-14 wherein an interior surface of the insulator gripping portion is contoured to form the one or more ear pockets.

EEE 16 is the assembly of any of EEEs 12-15, wherein the insulator gripping portion has a plurality of internal protrusions, and wherein the one or more ear pockets are interleaved between the plurality of internal protrusions.

EEE 17 is the assembly of any of EEEs 12-16, further comprising: a tee-shaped handle coupled to the insulator gripping portion, wherein the tee-shaped handle has a lateral portion and a transversal portion.

EEE 18 is the assembly of EEE 17, wherein the lateral portion has one or more holes to facilitate mounting the tool on a surface.

EEE 19 is the assembly of any of EEEs 17-18, wherein the lateral portion has a Lanyard loop attached thereto.

EEE 20 is a method for using the tool of any of EEEs 1-11 to form the assembly of any of EEEs 12-19 to secure an insulator to a post of an electric fence. For example, the method comprises: mounting an insulator to a post of an electric fence, wherein the insulator has an aperture through which the post is disposed, and wherein the insulator comprises one or more ears projecting radially outward therefrom; mounting a tool to the insulator such that the insulator is received partially within a receptacle formed within the tool, and wherein the one or more ears of the insulator are disposed respectively within one or more ear pockets formed within the tool; and rotating the tool, thereby causing at least a first component of the insulator to rotate therewith, thereby tightening a second component about the aperture and securing the insulator to the post.

EEE 21 is the method of EEE 20, wherein rotating the tool comprises rotating the tool by hand via the handle.

EEE 22 is the method of any of EEEs 20-21, wherein rotating the tool comprises rotating the tool via a wrench engaged with a socket drive hole formed in the tool.

EEE 23 is the method of any of EEEs 20-22, wherein the insulator comprises a first component having the one or more ears and internal threads, and a second component having external threads and a split portion, and wherein rotating the tool causes the internal threads of the first component to engage the external threads of the second component, thereby tightening the split portion about the aperture.

EEE 24 is the method of any of EEEs 20-23, further comprising: adjusting a vertical position of the insulator along the post prior to rotating the tool.

EEE 25 is the method of any of EEEs 20-24, further comprising: passing an electrified wire through a channel formed in the insulator after securing the insulator to the post.

EEE 26 is the method of any of EEEs 20-25, wherein the tool is a monolithic plastic part that is injection molded.

EEE 27 is the method of any of EEEs 20-25, wherein the tool is made using additive manufacturing processes.

EEE 28 is the method of any of EEEs 20-27, further comprising: attaching a retractable cable to a loop on the tool, wherein the retractable cable is mounted to a belt of a user.

EEE 29 is the tool of any of EEEs 1-11, wherein the tool body is a monolithic plastic part that is injection molded.

EEE 30 is the tool of any of EEEs 1-11, wherein the tool body is made using additive manufacturing processes.

EEE 31 is the tool of any of EEEs 1-11, wherein the tool body comprises engineered polymer.

EEE 32 is the tool of EEE 2, further comprising: a metal insert disposed within the socket drive hole.

EEE 33 is the assembly of any of EEEs 12-19, wherein the insulator comprises a first component having the one or more ears and internal threads, and a second component having external threads and a split portion configured to tighten about a post of the electric fence.

EEE 34 is the assembly of any of EEEs 12-19, wherein the insulator is configured as a gear wheel having a plurality of teeth as the one or more ears.

What is claimed is:

1. A tool for engaging an insulator of an electric fence, the tool comprising:
a tool body having an insulator gripping portion;
a receptacle formed within the insulator gripping portion and configured to receive at least a portion of the insulator therein; and
one or more ear pockets formed within the insulator gripping portion, wherein the one or more ear pockets are configured to receive respective ears of the insulator to rotatably engage with the insulator.

2. The tool of claim 1, wherein the tool body comprises:
a head portion, wherein the head portion comprises a socket drive hole.

3. The tool of claim 2, wherein the head portion has a smaller diameter compared to the insulator gripping portion.

4. The tool of claim 3, wherein the tool body further comprises:
a tapered portion that connects the head portion to the insulator gripping portion.

5. The tool of claim 1, wherein an interior surface of the insulator gripping portion is contoured to form the one or more ear pockets.

6. The tool of claim 1, wherein the insulator gripping portion has a plurality of internal protrusions, and wherein the one or more ear pockets are interleaved between the plurality of internal protrusions.

7. The tool of claim 1, further comprising:
a handle coupled to the insulator gripping portion.

8. The tool of claim 7, wherein the handle is tee-shaped such that the handle has a lateral portion and a transversal portion.

9. The tool of claim 8, wherein the transversal portion has an hour-glass shape.

10. The tool of claim 8, wherein the lateral portion has one or more holes to facilitate mounting the tool on a surface.

11. The tool of claim 8, wherein the lateral portion has a loop attached thereto.

12. An assembly comprising:
an insulator of an electric fence, wherein the insulator comprises one or more ears projecting radially outward therefrom; and
a tool for rotatably engaging the insulator, the tool comprising:
a tool body having an insulator gripping portion,
a receptacle formed within the insulator gripping portion, wherein the insulator is received partially within the insulator gripping portion, and
one or more ear pockets formed within the insulator gripping portion, wherein the one or more ears of the insulator are disposed within the one or more ear pockets.

13. The assembly of claim 12, wherein the tool body comprises:
a head portion, wherein the head portion comprises a socket drive hole.

14. The assembly of claim 13, wherein the tool body further comprises:
a tapered portion that connects the head portion to the insulator gripping portion.

15. The assembly of claim 12, wherein an interior surface of the insulator gripping portion is contoured to form the one or more ear pockets.

16. The assembly of claim 12, wherein the insulator gripping portion has a plurality of internal protrusions, and wherein the one or more ear pockets are interleaved between the plurality of internal protrusions.

17. The assembly of claim 12, further comprising:
a tee-shaped handle coupled to the insulator gripping portion, wherein the tee-shaped handle has a lateral portion and a transversal portion.

18. The assembly of claim 17, wherein the lateral portion has one or more holes to facilitate mounting the tool on a surface.

19. The assembly of claim 17, wherein the lateral portion has a Lanyard loop attached thereto.

20. A method comprising:
mounting an insulator to a post of an electric fence, wherein the insulator has an aperture through which the post is disposed, and wherein the insulator comprises one or more ears projecting radially outward therefrom;
mounting a tool to the insulator such that the insulator is received partially within a receptacle formed within the tool, and wherein the one or more ears of the insulator are disposed respectively within one or more ear pockets formed within the tool; and
rotating the tool, thereby causing at least a first component of the insulator to rotate therewith, thereby tightening a second component about the aperture and securing the insulator to the post.
